(19) United States
(12) Patent Application Publication
(10) Pub. No.: US 2017/0083914 A1
(43) Pub. Date: Mar. 23, 2017

(54) METHOD AND SYSTEM FOR MANAGING AUTHENTICATION SERVICES CUSTOMER DATA

(71) Applicant: MasterCard International Incorporated, Purchase, NY (US)

(72) Inventors: Paul Stephen Baker, West Yorkshire (GB); Robert Albert Ederle, Chesterfield, MO (US); John Artman, Lake Saint Louis, MO (US); Stephanie Dickinson, Collinsville, IL (US); Craig Gilbert, Chesterfield, MO (US); Karen Jeanne Gieselman, St. Louis, MO (US); Brian John Piel, Ballwin, MO (US)

(21) Appl. No.: 14/857,406

(22) Filed: Sep. 17, 2015

(51) Int. Cl. G06Q 20/40

(52) U.S. Cl. CPC G06Q 20/4014

(57) ABSTRACT

Methods, media, and systems directed to a platform for receiving, from at least one external user of an authentication system, a record including customer information for the external user and associated with at least an enrollment of the at least one external user to the authentication system; receiving, by a computer interfaced with an authentication database storing historical external user customer information, the record including the customer information for the external user; validating the record including customer information for the external user and the historical external user customer information; and storing an indication of the validated record.

### BACKGROUND

Historically, a major concern of merchants and issuers of payment devices (such as credit or debit cards and applications associated therewith) in online shopping contexts and other “card not present” transactions is whether the person attempting to use the payment device is an authorized user of the payment device. When a cardholder is not present, it may be difficult for the merchant or other entity to authenticate or verify whether the actual authorized cardholder is indeed authorizing a purchase, as opposed to some attempt of a type of fraudulent activity.

In an effort to reduce the incidence of payment device fraud in online purchase and other “card not present” transactions, a number of systems have been proposed and used to verify that the person using the payment device is an authorized user of payment device. In this regard, one security protocol developed to add a layer of additional security to online credit and debit transactions is the 3-D Secure (3DS) Protocol that couples the financial authorization process of a purchase transaction with an online authentication of the user or account completing the purchase transaction. This protocol was designed to allow a credit card issuer to authenticate their cardholder(s) while the cardholders shop online or in other “card not present” scenarios. However, 3DS and other authentication processes and systems proposed heretofore are typically closed-loop systems that are complex, costly to implement, and primarily directed to authenticating the identity of the cardholder.

Therefore, it is desirable to provide improved methods and systems that support the acquisition and processing of authentication data related to purchase transactions that is operationally stable, efficient, and scalable and includes improved data management functionalities.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, wherein:

FIG. 1 is an illustrative depiction of a system for use in a general cardholder authentication;

FIG. 2 is an illustrative depiction of a system for authentication processing, according to some embodiments herein;

FIG. 3 is an illustrative depiction of a system for authentication processing, including interfacing with external sources of authentication related data, according to some embodiments herein;

FIG. 4 is a logical architecture of an authentication platform, according to some embodiments herein;

FIG. 5 is a schematic block diagram of a system, according to some embodiments herein;

FIG. 6 is an illustrative depiction of a data exchange flow, according to some embodiments herein; and

FIG. 7 is a schematic block diagram of an apparatus, according to some embodiments herein.

### DETAILED DESCRIPTION

In general, and for the purpose of introducing concepts of embodiments of the present disclosure, an authentication security policy relates to a process of verifying cardholder account ownership during a transaction in an online electronic commerce (e-commerce) environment, where that transaction may include a purchase transaction. As used herein, the terms purchase transaction and payment transaction or simply transaction may be used interchangeably unless stated otherwise. In general, the purchase transactions herein refer to card not present or e-commerce transactions. As such, these transactions may be requested by a merchant or other entity to have the cardholder, user, or other entity presenting a payment device for payment or an account thereof verified as an authorized user of the payment device since, for example, a merchant cannot physically verify the user is even in possession of the payment device.

In accordance with some general aspects of the present disclosure, a framework for an authentication process, system, and method will be described that includes efficient and flexible data management functions and mechanisms. The data management functions and mechanisms of the authentication framework or platform herein include, but are not limited to, providing efficient and accurate control and management of a new customer enrollment process and billing aspects of the authentication platform. In some aspects, an authentication framework or platform herein provides mechanism(s) supporting customer enrollment/data management and billing solution(s) that are scalable to future business growth and customers' expectations. In some aspects, the authentication framework or platform herein supports and facilitates the accurate management of data related to aspects of issuer, payment processor, and merchant information in an authentication ecosystem.

payment device system, application, or service collects authentication data from various internal and external entities (e.g., applications, devices, services, etc.) of a business, enterprise, or organization within an authentication ecosystem, including but not limited to a 3DS environment, that can provide authentication services and stores the collected authentication data in a data repository such as a data warehouse, local or distributed storage facility, and a cloud based storage service. The collected authentication data may be used as a basis for business analytics including, for example, business reporting for internal and external customers of an enterprise or other business organization. Analysis based on the collected authentication data may, in some aspects, be utilized for transactional fraud scoring purposes. In some embodiments, data derived from the collected authentication data can be shared and used in combination with transaction data (e.g., purchase authorization data) within a data warehouse to provide a view of an end-to-end transaction lifecycle.

The present disclosure provides, at least in part, processes and systems for reporting an end-to-end or complete view of a transaction including authentication data used in the authorizing and processing of credit and other types of transactions. The authentication data determined, processed, collected, analyzed, and stored herein may be used to provide valuable insight into a business and other entities. Such insights may relate, but not be limited to, transactional patterns, authentication trends and patterns, card issuer authentication success and failure rates, fraud indicators due to multiple failures within certain card ranges or regions, cardholder trends on authentication abandonment, failure rates of certain authentication service providers, and trends on authentication methods used in particular transactions.

A number of methods, systems, and solutions have been proposed to provide a cardholder authentication process. One solution is MasterCard® SecureCode™ promulgated by the assignee of the present patent application that defines and provides a level of security relating to a cardholder authentication process. The MasterCard® SecureCode™ process incorporates aspects of the 3-D Secure™ Protocol Specification Core Functions, Version 1.0.2 effective 17 Apr. 2006. This particular implementation of 3-D Secure™ (also referred to herein as “3DS”) includes support for the SPA (Secure Payment Application) algorithm and Universal Cardholder Authentication Field (UCAF) without changing the 3-D Secure™ specification, messages, or protocol. While some aspects herein may build on, rely on, and leverage various aspects of the 3-D Secure™ specification, the processes and systems herein are not limited to a security authentication protocol or process adhering to that specification or even authentication flows that may fit within the 3DS protocol. Even in some instances herein where some embodiments may be described in the context of a system and process interfacing with at least some aspects of the 3-D Secure™ specification, other or alternative authentication security protocols may be substituted without any loss of generality, including those now known and those that may be developed in the future.

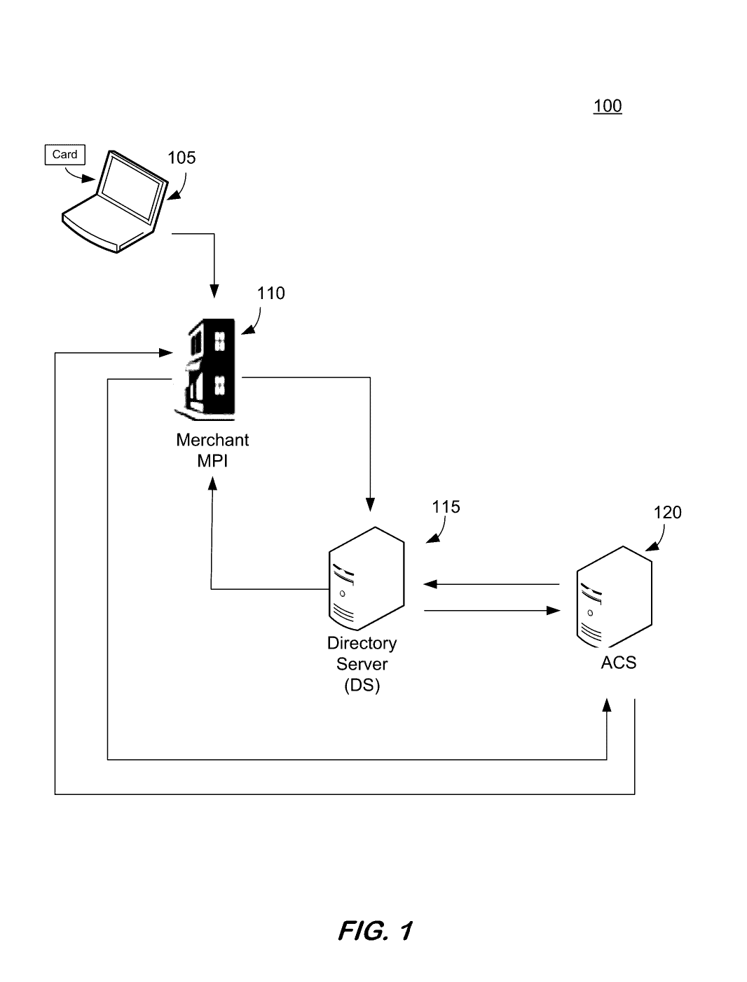

FIG. 1 is an illustrative diagram of a system 100 for implementing a process that may be utilized for verifying a cardholder account ownership (i.e., cardholder authentication) in accordance with the 3-D Secure™ specification. As such, FIG. 1 provides, in part, an overview of a cardholder authentication system and process in accordance with the 3-D Secure™ specification. However, all details of the specification are not discussed herein since a complete detailed disclosure of such information may be readily understood by directly referencing the 3-D Secure™ specification and or discussions thereof. Moreover, since the concepts and details disclosed herein are not limited to a specific authentication protocol such as 3DS, an exhaustive detailing of the 3DS is not a prerequisite for a complete understanding of the current disclosure.

System 100 includes a plurality of entities that must interact with each other by exchanging multiple, specifically formatted messages over secure communication channels (as defined in the 3-D Secure™ specification). Accordingly, the cardholder authentication process of FIG. 1 is complex given the number and extent of specific entities, messages, and other requirements necessarily involved.

System 100 includes a cardholder 105 that interacts with a merchant's online presence. Typically, cardholder 105 visits a merchant's Web site using a browser on their device of choice and selects items (e.g., goods and/or services) for purchase. As part of the online ordering process, cardholder 105 checks out and finalizes the purchase transaction by providing payment credentials to the merchant. The payment credentials may include at least a primary account number (PAN) representative of the account to be used as a source of funds in the transaction, an expiration date associated with the PAN, and (billing) address information of the cardholder. The PAN and other information is provided to the merchant's Merchant Server Plug-in (MPI) 110, where the MPI is a software module executed on behalf of the merchant. MPI 110 operates to determine whether payment authentication is available for the PAN received from the cardholder. The MPI formats and sends a Verify Enrollment Request (VEReq) message including the PAN to a Directory Sever (DS) 115, where the DS is a computer server that can determine whether the PAN is within a range of PANs enrolled in the authentication service provided by system 100. The DS may comprise a computer having at least one processor, a memory to store program instructions and data, and a communication interface to interface with other devices.

Upon receiving the VEReq, DS 115 queries an Access Control Server (ACS) 120 device, where the address of the ACS is specified in the VEReq. The address of the ACS may be specified using a Web address URL (uniform resource locator) for the ACS. The specified ACS may be an issuer of the account represented by the PAN. In some embodiments, the ACS may be acting on behalf of the issuer of the PAN and the specified URL points to a Web address other than that of the issuer. ACS 120 may respond to the query by providing an indication of whether authentication is available for the PAN included in the VEReq. If the merchant is a participating acquirer and the merchant is a valid merchant, then ACS 120 may respond with a Verify Enrollment Response (VERes) message that indicates that authentication is available for the PAN included in the VEReq message. ACS 120 uses the PAN from the VEReq to determine whether the cardholder is enrolled in the authentication service.

In some instances, the MPI may store data related the ranges of PANS enrolled in the authentication service and determine whether the PAN is within a range of PANs enrolled in the authentication service provided by system 100.

In some aspects, the VERes may include a flag that authentication is available for the PAN (e.g., a PAN Authentication Available field may be set to “Y” indicating authentication is available). Conversely, ACS 120 may respond with a VERes that indicates that authentication is not available for the PAN (e.g., acquirer BIN and/or PAN not enrolled, ACS unresponsive to query, etc.). In some aspects, the VERes may include a flag that authentication is not available for the PAN (e.g., a PAN Authentication Available field may be set to “N” indicating authentication is not available or “U” indicating authentication is unavailable). In the event the VERes includes a flag, a value in a field thereof, or other mechanism to indicate that authentication is not available for the PAN, the authentication process provided by system 100 may be terminate or aborted.

ACS 120 further sends the VERes including the indication of whether authentication is available to DS 115. DS 115 will then forward the VERes to MPI 110. This may conclude the DS's participation in the authentication of the transaction but the authentication process is far from complete. Upon receipt of the VERes, MPI 110 reads the response to see if authentication is available for the transaction's PAN. If authentication is available, then MPI 110 sends a message including a Payer Authentication Request (PAReq) message to ACS 120 via the cardholder's browser using the ACS URL included in the VERes. The PAReq message requests the issuer ACS to authenticate its cardholder. The PAReq may include cardholder, merchant, and transaction-specific information. The cardholder information may include security information known only to the cardholder and the issuer. It is noted that the PAReq message is not shared with the merchant (or the MPI).

ACS 120 receives the PAReq and may proceed to validate the received message to ensure that it is properly formatted and includes the requisite information, including for example, digital certificates and a proper PAN Authentication Available flag (e.g., “Y”). ACS 120 may further determine whether to provide authentication of the cardholder. ACS 120 may provide an indication of that determination by providing a status for the transaction. Values for the status may include, in accordance with 3-D Secure™, “Y” meaning the customer is fully authenticated, “N” meaning the customer failed or canceled authentication (i.e. transaction denied), “U” meaning the authentication could not be completed (e.g., technical issues such as communication failures, time-outs, etc.), and “A” that provides proof that the authentication was attempted.

A message is sent from ACS 120 to MPI 110 that includes the transaction status as determined by ACS 120. The message may comprise a Payer Authentication Response, PARes message. In the event the transaction status is determined to be “Y”, then the PARes will include an authentication token, AAV, that is sent to MPI 110. The PARes may be digitally signed to offer a level of security regarding the authenticity of the message itself. The PARes is received at MPI 110 through the cardholder's browser. Upon receipt of the PARes, MPI 110 may operate to validate the signature of the PARes and determine whether to authorize the transaction based, at least in part, on the values comprising the VERes.

If the cardholder is authenticated using the authentication process generally described above, then the purchase transaction may proceed to a purchase or payment authorization process and informs the MPI of the AAV value or token. The purchase authorization may be accomplished in a conventional manner after the MPI notifies the merchant payment system of the results of the authentication attempt.

It is again noted that the authentication of the cardholder or account as explained hereinabove with respect to FIG. 1 is just one example of an authentication flow compatible with the present disclosure. As such, other authentication flows and processes including at least some different entities communicating with each other using the same or different message types than those described above are within the scope of the present disclosure.

In some instances, if the authentication was not successful, the merchant may still proceed with a conventional transaction authorization without the authentication token, as an unauthenticated transaction. Liability for the processing of an unauthenticated transaction may in some such instances reside with the merchant. In accordance with some aspects herein, data including an indication of the unsuccessful cardholder authentication, will be documented and maintained.

As noted in conjunction with FIG. 1, numerous messages may typically be communicated between numerous different entities. As such, a cardholder authentication process may typically be a complex process given the number of parties involved, the number of specific messages that are exchanged between the different entities, the number of determinations that need to be made regarding the content of the exchanged messages, and the secure communication of the messages. In accordance with some aspects herein, all relevant phases of the authentication process are maintained in one or more tangible records, messages, or data structures.

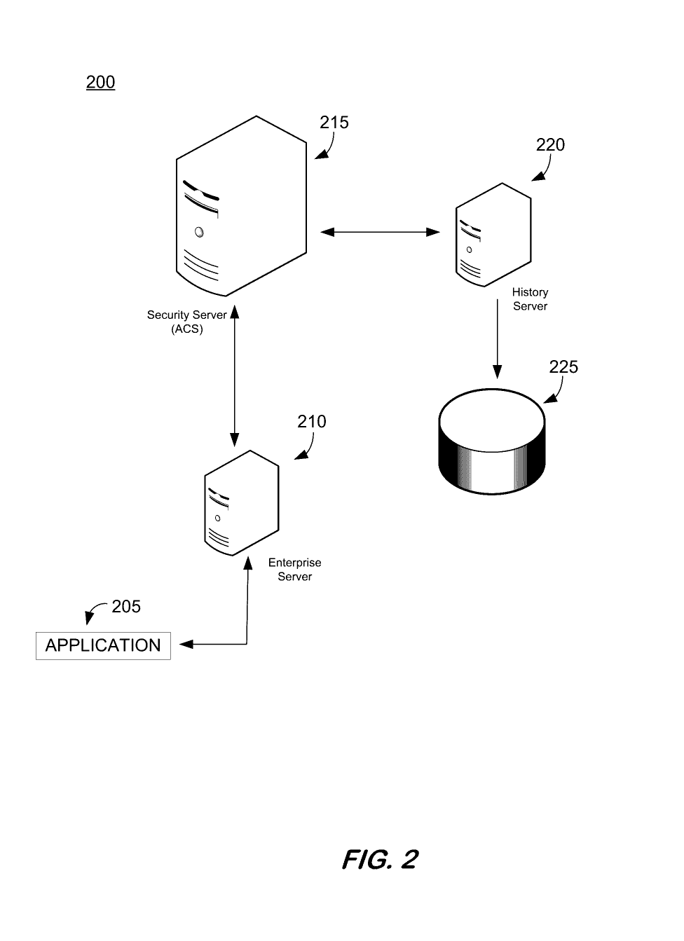

FIG. 2 discloses a system 200 in accordance with some embodiments herein. System 200 includes an application 205. In some embodiments, application 205 may be internal to an enterprise, business, or other organization. As used herein, an “internal” application, service, device, or system is not exposed to a system, device, service, or communication channel outside of the particular enterprise, business, or other organization. In some embodiments, application 205 may be a software application or service configured in accordance with an API (application program interface) specification herein. The API may be referred to as an authentication API herein. The authentication API may specify the information to be included in an exchange of information between application 205 and another software application, device, system, or service such as, for example, an enterprise server 210. Enterprise server 210 may operate to receive a request for an authentication value or token from application 205 via an API call and in reply to that API call (i.e., request) send an authentication value via an API response to software application 205.

In some embodiments, the requested authentication value may comprise a security code that is compatible with a Universal Cardholder Authentication Field (UCAF) data structure that is compatible with an authentication payment environment. It is noted however that an authentication value in some embodiments herein is not limited to the UCAF data structure or an instance thereof. In accordance with some aspects herein, the requested authentication value may be compatible with one or more authentication flows being utilized in a particular transaction and/or use-case.

In some embodiments, the authentication payment environment may comprise a three-domain (3-D) security protocol, although other authentication flows and protocols may be used in some embodiments. In some embodiments and aspects, a process of generating and communicating the API call and the API response in reply thereto and the systems and devices to execute that process are separate and distinct from the security protocol. In some embodiments, aspects of a method and process herein may, in some instances, provide information to and/or receive information from a process and system comprising a security protocol but be distinct therefrom.

In one aspect, the request for an authentication value or token may be for a specific, particular transaction, where the authentication value returned or sent to calling application 205 in reply to the API call provides an authentication value that is valid for and specifically associated with the transaction specified in the API call. In some embodiments, the authentication value or token sent from enterprise server 210 to application 205 may be used by application 205 and/or other applications, systems, devices, and services in one or more processes performed by application 205 and/or the other applications, systems, devices, and services. As an example, the authentication value generated by enterprise server 210 and sent to application 205 in response to the API call from the application may be used as an indicator (i.e., proof) of a verified authentication and further included in a payment transaction authorization request or other process. In some embodiments, the authentication value may be formatted and encoded in a suitable manner (e.g., formatted, encoded, encrypted, etc.) such that a particular authorization request including the authentication value herein need not be altered to accommodate the authentication value and otherwise be processed. Accordingly, some embodiments of FIG. 2 may interface with and accommodate systems and processes including those currently known and future developed systems and process that may, at least in part, conform to one or more security protocols. In at least one use-case, the authentication value may be further used in a purchase transaction process including, at least in part, a purchase transaction authorization (e.g., credit card authorization). In some other embodiments, the authentication value obtained by enterprise server 210 in reply to the request by application 205 may be further formatted and/or encoded in a manner to accommodate the request and be compatible with the requesting application 205.

In some embodiments, it is noted that application 205 makes the authentication request using a single API call to enterprise server 210. Conversely, the enterprise server may provide a reply to application 205 using a single API response. In this manner, an authentication value may be obtained in an efficient process by requesting and receiving an authentication value or token using a single API call from an application. In some aspects, this is in contrast to some embodiments of the processes disclosed in reference to, for example, FIG. 1, that involve multiple different entities that necessarily communicate with each in a specific sequence(s) while exchanging specific messages adhering to specific message formats and communication session requirements, per a specific security protocol.

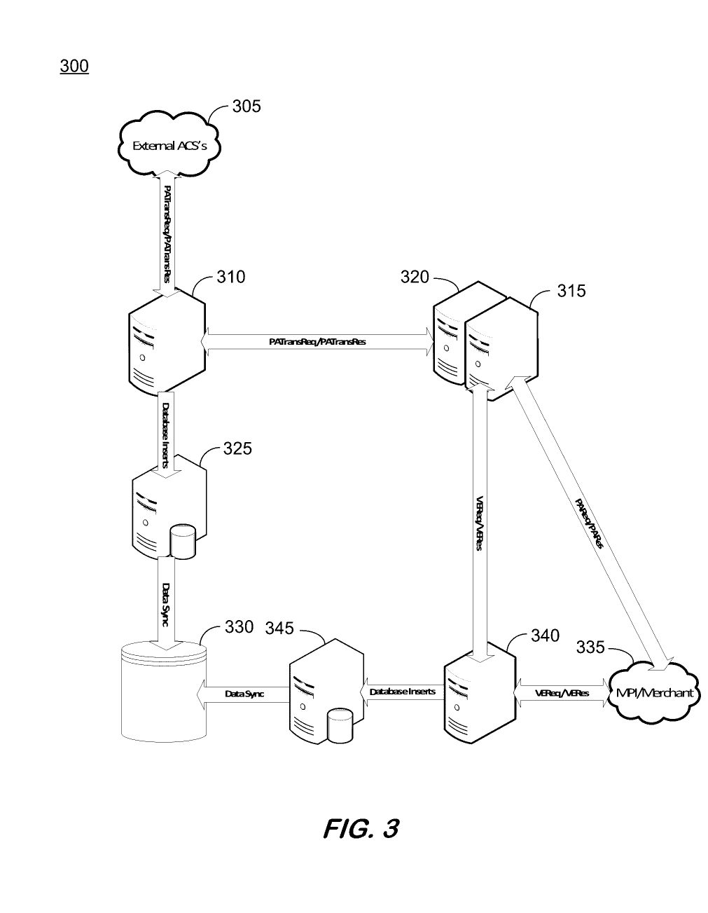

Referring to FIG. 3, an illustrative depiction of a system 300 according to some embodiments herein is shown. In some regards, FIG. 3 discloses logical aspects of an authentication platform including a history server that may record and log an end-to-end transaction flow of every authentication request of an authentication process (e.g., including 3-D Secure™ but not limited thereto). Accordingly, actual systems may include fewer, more, or different devices and entities in arrangements not explicitly shown in FIG. 3, without any loss of generality or applicability. In some aspects, system 300 may include a platform that may leverage some aspects of a conventional authentication system such as that disclosed in FIG. 1 (though not limited thereto), as well as some aspects of the system disclosed in FIG. 3. In some aspects, system 300 and the processes implemented thereby may operate to process millions of transactions and authentication requests, every single day. Such processing scope and scale, including every authentication request whether the authentication request was completed and the initial purchase transaction is also represented in an associated purchase authorization or whether the authentication request was completed, is made possible by system 300. Accordingly, system 300 necessarily comprises computer devices, systems, and networks that are improved, as opposed to being limited to implementing a known process.

In some aspects, system 300 includes an application server 310 that may receive payer authentication request (PAReq) messages or other message(s) depending on the authentication protocol being used and payer authentication request (PARes) messages or other message(s) depending on the authentication protocol being used associated with transaction from one or more sources. In accordance with some authentication systems and processes, the PAReq or other messages and PARes or other messages may be received from an ACS 305 external to an enterprise environment. In some aspects, the PAReq messages and PARes messages may be received from an issuer ACS of a system configured, at least in part, similar to system 100 of FIG. 1. The transaction PAReq and PARes or other data received from the external ACS's may be requested from external ACS provider(s). The PAReq and PARes data received by server 410 may be sent to a database server 425. Server 425, also referred to herein as a “history server”, may operate to track, store, format, encode, and/or encrypt the received data to insert the PAReq and PARes or other authentication data into a database table, system, other data structures, and a data storage service.

In some aspects, server 310 may receive PAReq and PARes data associated with transactions from one or more servers internal to an enterprise environment, such as, for example, from servers 315 and 320. Servers 315 and 320 may be one or more devices or systems functioning as, at least in part, an ACS. In some embodiments, ACS 315 is an internal ACS that may be internal to an enterprise environment such as, for example, the security (ACS) server 215 of FIG. 2. As stated earlier with respect to FIG. 2, system 200 including the enterprise server 210 and other components therein may operate internal to an enterprise environment wherein enterprise 200 generates an authentication value in response to an API call from application or service 205. In accordance with the generation of the authentication value, ACS 315 may have transaction PAReq and PARes data or other message(s) depending on the authentication protocol being used.

In some embodiments, server 320 may include an online authentication service ACS provided by an enterprise, whereas in some embodiments server 320 may include other types of ACS servers that may, at least on occasion, communicate with applications, devices, and/or services external to the enterprise environment. Server 320 may have transaction PAReq and PARes data or other authentication data associated with certain online and other types of transactions. The PAReq and PARes or other authentication data from servers 315 and 320 may be transmitted to application server 310 and then to history server 325.

Other aspects of the authentication process data, namely the verify enrollment request (VEReq) messages and verify enrollment response (VERes) messages or other message(s) depending on the authentication protocol being used may be received from one or more servers 315 (e.g., the internal ACS server) and a directory server (DS) 340. In some aspects, server 315 is the internal ACS that may facilitate the internal generation of an authentication value for a transaction, as discussed with respect to FIG. 2. As such, the VEReq and VERes data corresponding to the associated transaction(s) is stored by internal ACS 315. This VEReq and VERes or other message(s) may be transmitted to an application server 340 for, at least, storage purposes.

In some instances, VEReq and VERes or other message(s) may be generated with the assistance and in cooperation with external devices, applications, and services, such as system 100 of FIG. 1. Accordingly, the VEReq and VERes or other data associated with some transactions may be received via server 340 from a merchant MPI interface 335 and stored on DS 340.

In some aspects, whether the VEReq and VERes data is received from an internal ACS or a DS 340, server 340 may operate to track, store, format, encode, and/or encrypt the received data to insert the VEReq and VERes or other data into a database table, system, and other data structures. In some embodiments, an indication of the source or the type of device that provides the VEReq and VERes or other data is included in the VEReq and VERes data or other message(s) depending on the authentication protocol being used. This source indicator may provide insight into whether the authentication token request associated with a particular transaction was generated by an internal process (e.g., FIG. 2) or an external process, device, service, or system.

The data in both history server 325 (i.e., PAReq and PARes or other data) and DS server 345 (i.e., VEReq and VERes or other data) may be synced and otherwise processed, combined, or aggregated for inclusion in a data warehouse, storage facility, device, or system 330. In some embodiments, data warehouse 330 may comprise a database management system or an instance of a node of a database management system. In some aspects, the combined PAReq/PARes or other data and the VEReq/VERes or other data may comprise a single data record or data structure representation thereof. The combined data record may provide, in addition to other transaction details, an end-to-end view of a transaction flow, including whether authentication was requested by a merchant, whether the authentication was provided by an issuer, whether the authentication was approved or denied, and whether payment authorization for the transaction was requested and whether it was approved or denied.

In some aspects, the data in the data warehouse 330 may be accessed by other systems and devices (not shown) and used to provide insight into the transactions. In some instances, enterprise level analytics may be used to analyze the data to, for example, generate reports, presentations, and dashboards. In some aspects, the data in data warehouse 330 may be used by various organizations of an enterprise to, for example, settle transaction disputes, to manage and respond to issuer or merchant complaints, to manage compliance programs, to manage abandonment rates, etc. In some embodiments, system 300 facilitates and enables the functionality to determine unique patterns in transactions and better ascertain user and merchant practices (e.g, fraud, etc.) than previous methods of transactional data collection.

In some embodiments, the authentication data processed and collected in accordance with some aspects herein may be used in a process, system, and device to score or provide an indication of a risk level of a particular transaction based on, for example, historical authentication patterns and/or historical authentication velocities of an account or identity. In this and other contexts, the historical authentication activity may, at least in part, be compared to a current request to determine whether the authentication data falls outside (within) observed, expected, desired, calculated, or predicted patterns, ranges, and “norms”. In some aspects, the authentication data processed and stored herein may be aggregated in an effort to facilitate analyzing, storing, retrieving, and reporting functions using the data.

As part of an authentication ecosystem or platform 500 herein, on-behalf authentication services 505 may be called by an Access Control Server (ACS) or some other system to provide the actual authentication in an “out of band” method, which can include, for example, a one-time passcode generation and validation service, a mobile application, a biometric validation service, and other types of services, processes, applications, and use-cases. The results of all of these and other requests can also be fed into a data repository within a data warehouse that can be interfaced with other data to provide detailed transactional reporting and analytics.

In some embodiments, an authentication API in accordance with some aspects herein may include one or more data fields. Table 1 below is a tabular listing of some data fields that may be specified for implementing an API that may be used by a web service or application in accordance with some embodiments herein. In some embodiments, the data fields listed in Table 1 may be described in an interface description language (e.g., Web Service Description Language, WSDL) and provided to a developer of a web service or application for use by the developer or other entity to generate a web service or application that may effectively communicate using an appropriately define API.

In some embodiments, the authentication API may require or expect a value to be specified for all of the data fields listed in Table 1. That is, the API call may include a corresponding value for each of the data fields listed in the table. In some other embodiments, some but not necessarily all of the data fields specified in Table 1 may have a corresponding value supplied in the API call. For example, some instances of an authentication API herein may specify a value for a PAN (i.e., payment account number), a merchant name, and an expiry date corresponding to the PAN. These minimal values may be included in the API call and may be sufficient for the request of an authentication value in some embodiments herein. In accordance with some embodiments herein, the data received by or provided to an authentication history server herein contains at least some of the following components:

TABLE 1

Merchant Name
Merchant Country Code
Merchant URL
Merchant ID
Acquirer BIN
Purchase Date
Transaction Identifier
Purchase Amount
Purchase Currency
Currency Exponent
Recurring Payment Data
Installment Payment Data
PAN
Card Expiry Date
Account Identifier
Transaction Time
Transaction Status
Authentication Values
Transaction Indicator
Customer IP Address
Authentication Method Used

Table 1 includes an illustrative sample listing of data for some embodiments herein. The listed data may not be holistic or exhaustive. Accordingly, other data such as high level cardholder information and other transactional data may also be stored or received by and/or provided to an authentication history server in some embodiments herein.

In some embodiments, an application operative in accordance with process 300 may include an electronic payment wallet application developed on behalf of an issuer. As part of the development and deployment of the electronic wallet, authentication of the electronic wallet may be assigned or passed to a payment network provider or other entity. At the time of a log-in for the wallet application, there may be some level of authentication that verifies the authenticity or identity of the wallet application with the issuer of the wallet. Accordingly, there may not be a need for a merchant at the time of a purchase involving a customer to authenticate the wallet at a check-out since the wallet application has already been authenticated with the issuer. In some instances, the wallet authentication is done as part of a wallet initiation process.

While the user associated with the wallet application of this example has already been authenticated with the issuer to a level of authentication determined and designed to satisfy the concern(s) of the issuer and/or others (i.e., “pre-authenticated”), the particular authentication may not provide an authentication value or token such as an AAV value that may normally be generated by and/or in accordance with a security protocol. In an effort to obtain an authentication value or token (e.g., a AAV value), the electronic wallet application may request the authentication value via an API call in accordance with the present disclosure. The API call may be presented directly to a service to pull an authentication value therefrom. In some aspects, the API call from the application may obtain the authentication value without the need to satisfy all of the requirements of one or more security protocols since, for example, the issuer or an entity acting on behalf thereof has agreed to processing of the API call given certain conditions are satisfied. In some embodiments, an agreement to accept and process the API calls from an application in accordance with the present disclosure are determined before the API call is received by an enterprise server herein (e.g., before an operation 305 of process 300). In some aspects, the authentication of the electronic wallet in the present example may be said to comprise a pre-authorized authentication.

In some embodiments, a policy governing the authentication of the electronic wallet or other calling application may vary depending on the calling application, the intended use of the authentication value or token by the calling application, and other considerations.

Continuing with the electronic wallet example, in an instance a customer cardholder logs into a merchant's wallet service, the customer registered with the wallet service may be considered to have already been authenticated (i.e., pre-authorized authentication). In this case however, an authentication value or token may be desired for use in a payment authorization request associated with a purchase transaction of the customer. In some embodiments, the payment authorization request will be expected by an issuer (or entity acting on behalf thereof) to include the authentication value or token. In some aspects, the payment authorization may not be processed in the absence of the expected authentication value or token.

In some embodiments, inclusion of the authentication value or token in the payment authorization request may facilitate processing of the payment authorization in accordance with a known, predetermined, or future developed process flow. The absence of the expected authentication value or token in the payment authorization request may trigger the processing of the payment authorization in accordance with an alternative or “exceptions” process flow or a termination of the process flow.

Referring to FIG. 2, in some embodiments security server 215 may forward a record or representation of the authentication value or token generated by enterprise server 210 to a history server 220. History server 220 may further send transaction details to a database 225. The transaction details may be used in further processing, reporting, and analytics.

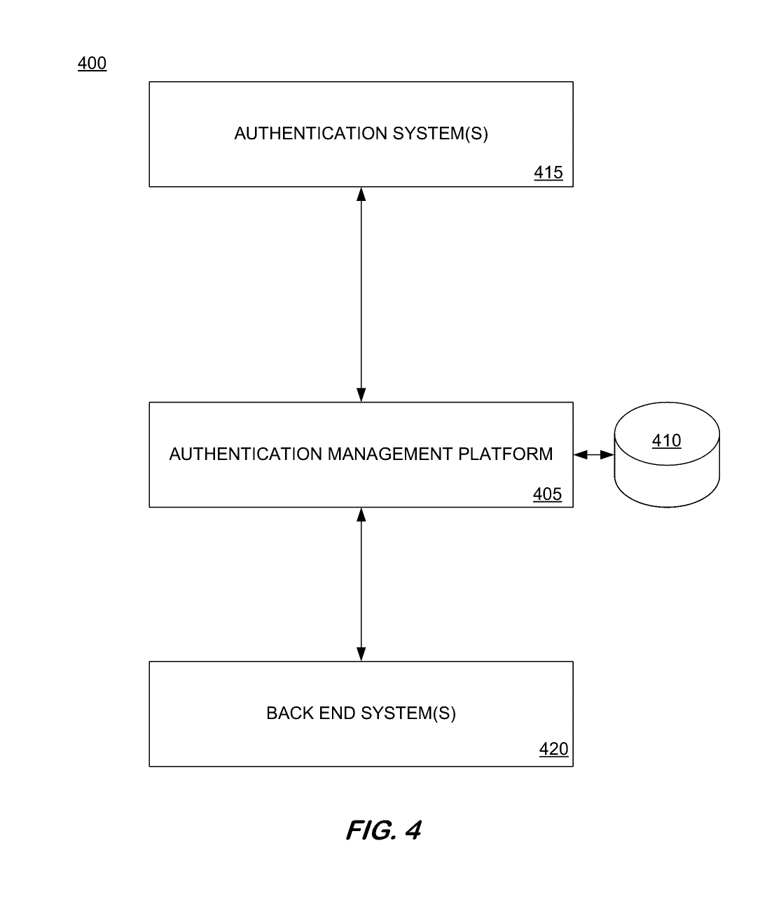

FIG. 4 is a block diagram of a system 400 according to some embodiments herein. System 400 may include an authentication data management platform 405 that interfaces with or otherwise communicates with one or more authentication systems, devices, applications, services 415. In some embodiments, authentication management platform 405 may support and facilitate an acquisition, updating, and analysis of customer data and other data related to authentication services. In some aspects, authentication systems 415 may include or relate to 3DS authentication systems, services, and applications, although embodiments of the present disclosure including authentication management platform 405 are not limited or restricted to communicating or interfacing with authentication systems implementing the 3DS authentication protocol. In some embodiments, the one or more authentication systems may or may not be interoperable with each other. Whether or not the one or more authentication systems 415 are interoperable with each other, each of the authentication systems 415 may communicate or otherwise interface with authentication management platform 405. In some instances, communication messages, commands, and/or instructions transmitted and received between authentication systems 415 and authentication management platform 405 may be facilitated by one or more communication interfaces or other devices, services, or applications (not shown) to ensure compatibility of such messages between the authentication systems 415 and authentication management platform 405.

Authentication management platform 405 may include or at least have access rights to one or more data storage facilities or repositories 410. In some embodiments, data repository 410 may include a relational database comprising one or more database nodes and manage data for a business enterprise providing, in some instances, data management functions related to authentication services, including but not limited to customer enrollment and customer data management (i.e., also referred to herein as customer enrollment/data management) and billing solution aspects. Repository 410 may house and manage all aspects and types of data in various data structures such as, for example, customer contact data related to customers in one or more different organizations within an organization, department, or other business entities of the enterprise. Authentication management platform 400 may further include back end systems 420 to support the data acquisition, data processing, and data management functions of authentication platform 405. In some embodiments, back end systems may be organized, at least logically, with business organizations of a business enterprise.

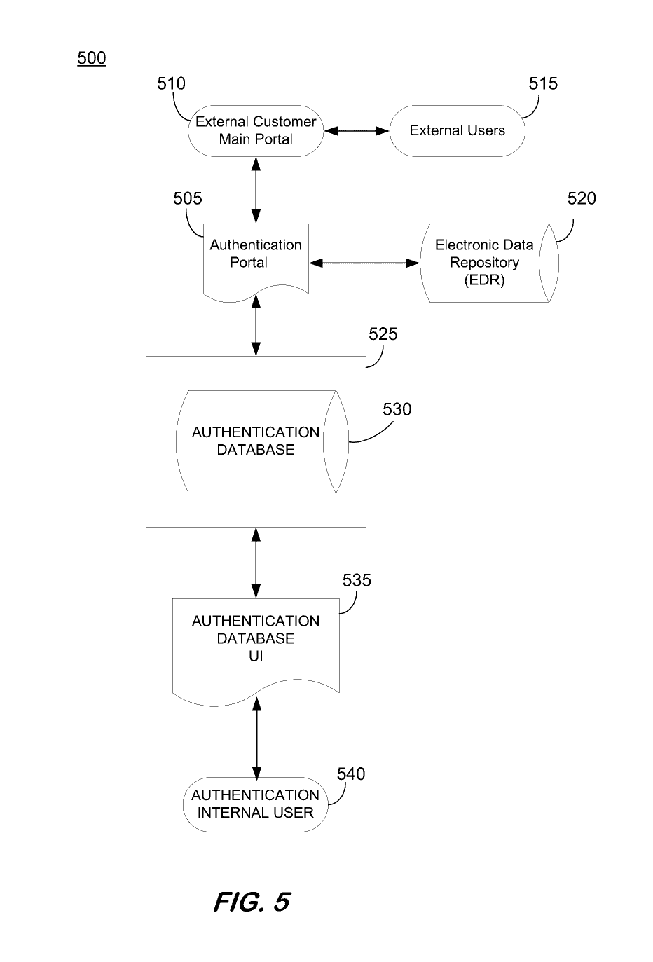

FIG. 5 is an illustrative depiction of a logical architecture 500 for a system, in accordance with some embodiments herein. In some embodiments, functions provided, supported, and facilitated by system 500 may be provided or implemented by an authentication management platform such as, for example, platform 400. Actual implementations of system 500 may include more or different components than those explicitly depicted in FIG. 5 and may be arranged in other configurations, not just the configuration shown in FIG. 5. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may include any number of hardware and/or software elements suitable to provide the functions described herein as well as any other functions. For example, any computing device used in an implementation of some embodiments may include a processor to execute program code such that the computing device operates as described herein.

System 500 includes an authentication portal 505. Novel authentication portal 505 provides a mechanism for one or more external users (i.e., users external to an enterprise or business organization providing the services or functions of system 500) to communicate with and otherwise have access to authentication information managed by an authentication management platform herein. In some aspects, external users 515 may interface with authentication portal 505 via an external customer main portal 510. In some embodiments, external customer main portal 510 may include, at least in part, an outwardly facing graphical user interface that can be accessed by a computer or processor-enabled device such as a computer, tablet, or smartphone running an applicable application (e.g., “app”). External customer main portal 510 may be, in some embodiments, implemented and/or accessed via a browser, a browser extension, or an application programming interface (API). In some instances, external users 515 may include issuers, acquirers, and authorized third parties (e.g., issuer and acquirer service providers) that are enrolled or potentially enrolled in authentication services and applications of an authentication platform herein. In some embodiments, contact information for external customers 515 may be stored and managed by some implementations of external customer main portal 510.

An electronic data repository (EDR) 520 is included in system 500. EDR 520 may include a data storage facility such as a relational database management system to store, maintain, and manage, for example, historical data related to existing external customers 515 of an authentication platform herein. EDR 520 may include, at least in part, a cloud-based storage service, system, or application. In some embodiments, EDR 520 may be a centralized or a distributed database system comprising one or more database nodes or instances. EDR 520 may operate as a validation point for data being entered into or otherwise obtained by system 500 from external customers 500 in an on-going effort to ensure that such data is consistent with and accurately corresponds to data already known and being managed by an enterprise. In some embodiments, EDR 520 may automatically, based on one or more rules or actionable triggers, updated and validate data herein.

In some aspects, system 500 further includes a decision management platform or service 525. Decision management platform 525 may be a data management device or system (e.g., a relational database system) that stores the external customer information for the external customer 515 issuers, acquirers, and authorized third parties. In some particular embodiments, decision management platform or service 525 may include an authentication database 530. Authentication database 530 may store and maintain records, files, and other data structures representative of customer data including, but not limited to, contracts, notes (e.g., messages, documents, unstructured data, etc.), certification information, credit card ranges, payment device BINs (Bank Identification Numbers), merchant information, and other data.

System 500 may include an authentication database user interface 535 that provides, internal to an enterprise, an interface for internal authentication users 540 to access and otherwise communicate with decision management platform 525. In some aspects, authentication database user interface 535 provides a mechanism for internal authentication users 540 to access authentication information of an authentication platform to provide or at least facilitate customer support functions and business or analyst access to external customer authentication related data (e.g., contact information, billing information, etc.). Access to authentication database via authentication database user interface 535 may be restricted to the internal authentication users depending on a role of the internal authentication user(s).

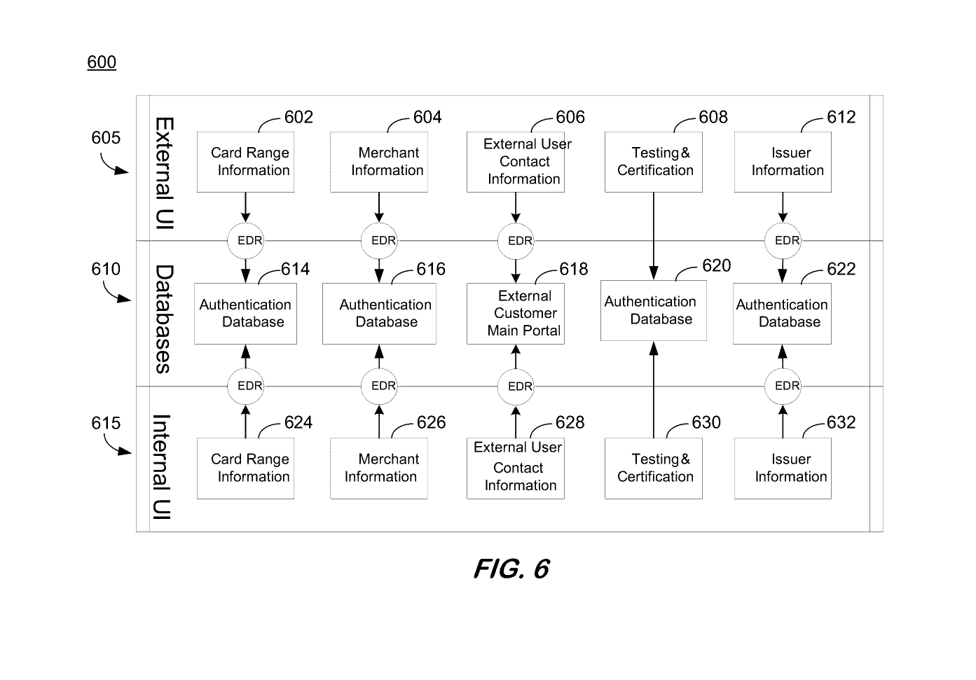

FIG. 6 is an illustrative logical depiction for an exchange of data that may be performed by an authentication platform, in accordance with some embodiments herein. Data of FIG. 6 may generally be stored and maintained by databases 610 that may be accessed by external users via an external user interface 604 and accessed by internal authentication users through an internal user interface 615. A number of different types of data can be provided to databases 610 via external UI 605, including card range information 602, merchant information 604, external user contact information 606, testing and certification data 608, and issuer information 612. Other aspects and types of data related to one or more external users of an authentication platform may be encompassed in some instances and embodiments herein, in addition to or as a substitute to the external user information shown in FIG. 6.

In some embodiments, a number of different types of data can be provided to databases 610 via internal UI 615, including historical card range information 624, merchant information 626, external user contact information 628, testing and certification data 630, and issuer information 632. Other aspects and types of data related to one or more internal users of an authentication platform herein may be encompassed in some instances and embodiments herein, in addition to or as a substitute to the specific user information shown in FIG. 6.

In some aspects, external customer main portal 618 provides similar functionality as the external customer main portal 510 of FIG. 5 and instances of the authentication database 614, 616, 620, and 622 shown in FIG. 6 may provide similar functionality as the authentication database 530 shown in FIG. 5. In some aspects herein, an EDR such as EDR 520 of FIG. 5 provides numerous validation points for the data exchanged between external users, internal users, and the databases represented in FIG. 6.

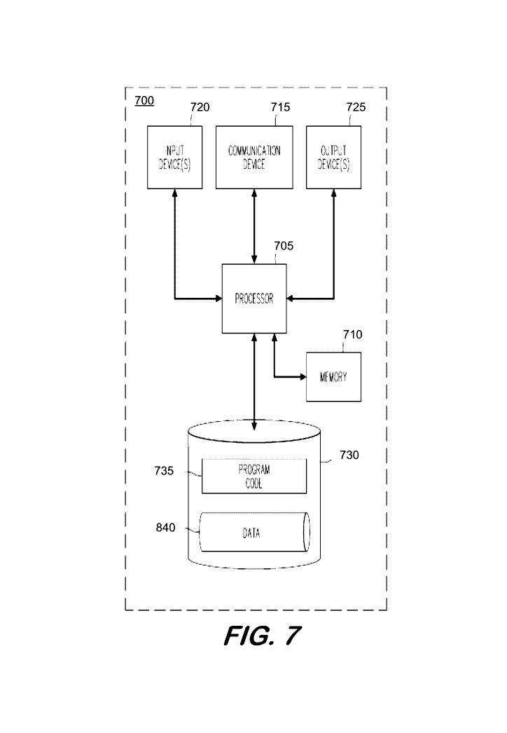

FIG. 7 is a block diagram overview of a system or apparatus 700 according to some embodiments. System 700 may be, for example, associated with any of the devices described herein, including for example an enterprise server, an authentication database server, and like functionality in accordance with processes disclosed herein. System 700 comprises a processor 705, such as one or more commercially available Central Processing Units (CPUs) in the form of one-chip microprocessors or a multi-core processor, coupled to a communication device 715 configured to communicate via a communication network (not shown in FIG. 7) to another device or system. In the instance system 700 comprises a server (e.g., supporting the functions and services provided by an authentication platform herein), communication device 715 may provide a mechanism for system 700 to interface with another device, system, or service (e.g., an instance of an authentication system). System 700 may also include a local memory 710, such as RAM memory modules. The system further includes an input device 720 (e.g., a touchscreen, mouse and/or keyboard to enter content) and an output device 725 (e.g., a touchscreen, a computer monitor to display, a LCD display).

Processor 705 communicates with a storage device 730. Storage device 730 may comprise any appropriate information storage device, including combinations of magnetic storage devices (e.g., a hard disk drive), optical storage devices, solid state drives, and/or semiconductor memory devices. In some embodiments, storage device 630 may comprise a database system.

Storage device 730 may store program code or instructions 735 that may provide computer executable instructions for updating and validating customer authentication data and storing the data records thereof further processing, analysis, and reporting purposes, in accordance with processes herein. Processor 705 may perform the instructions of the program instructions 735 to thereby operate in accordance with any of the embodiments described herein. Program code 735 may be stored in a compressed, uncompiled and/or encrypted format. Program code 735 may furthermore include other program elements, such as an operating system, a database management system, and/or device drivers used by the processor 705 to interface with, for example, peripheral devices. Storage device 730 may also include data 740 such as database records or look-up tables, including for example records of merchants, issuers, and acquirers participating in a particular authentication program or service and the addresses of the devices used by those entities to implement the service. Data 740 may be used by system 700, in some aspects, in performing one or more of the processes herein, including individual processes, individual operations of those processes, and combinations of the individual processes and the individual process operations.

All systems and processes discussed herein may be embodied in program instructions stored on one or more non-transitory computer-readable, processor-executable media. Such media may include, for example, a solid state drive, a floppy disk, a CD-ROM, a DVD-ROM, magnetic tape, and solid state Random Access Memory (RAM) or Read Only Memory (ROM) storage units. According to some embodiments, a memory storage unit may be associated with access patterns and may be independent from the device (e.g., magnetic, optoelectronic, semiconductor/solid-state, etc.) Moreover, in-memory technologies may be used such that databases, etc. may be completely operated in RAM memory at a processor. Embodiments are therefore not limited to any specific combination of hardware and software.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method, the method comprising:
receiving, by a computer from at least one external user of an authentication system, a record including customer information for the external user and associated with at least an enrollment of the at least one external user with the authentication system;
receiving, by a computer interfaced with an authentication database storing historical external user customer information, the record including the customer information for the external user;
validating the record including the customer information for the external user and the historical external user customer information; and
storing an indication of the validated record.

2. The method of claim 1, wherein the validating of the record including customer information for the external user is performed automatically as the record including customer information for the external user is received.

3. The method of claim 1, wherein the external user is at least one of an issuer, an acquirer, and a third party entity authorized to act on behalf of an issuer or an acquirer.

4. The method of claim 1, wherein the authentication database comprises a relational database system.

5. The method of claim 1, wherein the validating is performed for all data received from the at least one external user.

6. The method of claim 1, wherein the historical data is obtained from an internal authentication user and the historical data is further validated against the record including the customer information received from the external user.

7. The method of claim 1, wherein the authentication database stores data for an authentication system implementing a first authentication protocol and the record including the customer information includes at least enrollment information for the at least one external user for an authentication system implementing the first authentication protocol.

8. A system comprising:
an authentication server; and
an apparatus comprising:
a processor; and
a memory device in communication with the processor and storing program instructions thereon, the processor operative with the program instructions to:
receive, from at least one external user of an authentication system, a record including customer information for the external user and associated with at least an enrollment of the at least one external user with the authentication system;
receive, from an authentication database storing historical external user customer information, the record including the customer information for the external user;
validate the record including the customer information for the external user and the historical external user customer information; and
store an indication of the validated record.

9. The system of claim 8, wherein the validating of the record including customer information for the external user is performed automatically as the record including customer information for the external user is received.

10. The system of claim 8, wherein the external user is at least one of an issuer, an acquirer, and a third party entity authorized to act on behalf of an issuer or an acquirer.

11. The system of claim 8, wherein the authentication database comprises a relational database system.

12. The system of claim 8, wherein the validating is performed for all data received from the at least one external user.

13. The system of claim 8, wherein the historical data is obtained from an internal authentication user and the historical data is further validated against the record including the customer information received from the external user.

14. The system of claim 8, wherein the authentication database stores data for an authentication system implementing a first authentication protocol and the record including the customer information includes at least enrollment information for the at least one external user for an authentication system implementing the first authentication protocol.

15. A medium having program instructions stored thereon, the medium comprising:
program instructions to receive, from at least one external user of an authentication system, a record including customer information for the external user and associated with at least an enrollment of the at least one external user with the authentication system;
program instructions to receive, from an authentication database storing historical external user customer information, the record including the customer information for the external user;
program instructions to validate the record including the customer information for the external user and the historical external user customer information; and
program instructions to store an indication of the validated record.

16. The medium of claim 15, wherein the validating of the record including customer information for the external user is performed automatically as the record including customer information for the external user is received.

17. The medium of claim 15, wherein the external user is at least one of an issuer, an acquirer, and a third party entity authorized to act on behalf of an issuer or an acquirer.

18. The medium of claim 15, wherein the authentication database comprises a relational database system.

19. The medium of claim 15, wherein the validating is performed for all data received from the at least one external user.

20. The medium of claim 15, wherein the historical data is obtained from an internal authentication user and the historical data is further validated against the record including the customer information received from the external user.

21. The medium of claim 15, wherein the authentication database stores data for an authentication system implementing a first authentication protocol and the record including the customer information includes at least enrollment information for the at least one external user for an authentication system implementing the first authentication protocol.
